(19) United States
(12) Patent Application Publication
(10) Pub. No.: US 2025/0172387 A1
(43) Pub. Date: May 29, 2025

(54) FOUR-WHEEL ALIGNER

(71) Applicant: SHENZHEN SMARTSAFE TECH CO.,LTD., Shenzhen (CN)

(72) Inventors: Wei ZHAN, Shenzhen (CN); Qingwei WANG, Shenzhen (CN); Shaoli GU, Shenzhen (CN)

(73) Assignee: SHENZHEN SMARTSAFE TECH CO.,LTD., Shenzhen (CN)

(21) Appl. No.: 18/673,540

(22) Filed: May 24, 2024

(30) Foreign Application Priority Data
Nov. 29, 2023 (CN) 202311635676.3

(51) Int. Cl. G01B 11/275; G06T 7/73; G06T 7/80; H04N 23/90

(52) U.S. Cl. CPC G01B 11/2755; G06T 7/73; H04N 23/90; G01B 2210/146; G01B 2210/286

(57) ABSTRACT

A four-wheel aligner including four four-wheel alignment and measuring devices and two four-wheel alignment and calibration devices; one of the two four-wheel alignment and calibration devices is arranged between two of the four four-wheel alignment and measuring devices located at a side of the vehicle to be aligned, another one of the two four-wheel alignment and calibration devices is arranged between another two of the four four-wheel alignment and measuring devices located at another side of the vehicle to be aligned, and the two four-wheel alignment and calibration devices are configured to be oppositely arranged on two sides of the vehicle to be aligned; the four four-wheel alignment and measuring devices are configured to obtain images of the tires and to analyze alignment information of the tires.

### CROSS-REFERENCE TO RELATED APPLICATION

The present application claims priority of a Chinese patent application, with application Ser. No. 202311635676.3, filed on Nov. 29, 2023; the contents of which are incorporated herein by reference.

### TECHNICAL FIELD

The present application relates to the technical field of measuring tires of a vehicle, and more specifically to a four-wheel aligner.

### BACKGROUND

The mounting among the steering wheels, steering knuckles, and front axle of a vehicle has a certain relative position, and the mounting with a certain relative position is called steering wheel alignment, also known as front wheel alignment. The front wheel alignment includes four aspects: a kingpin castor (angle), a kingpin inclination (angle), a front wheel camber (angle), and a front wheel toe in. This is for the two steering front wheels, and for the two rear wheels there is also a relative position of mounting between the two rear wheels, also known as rear wheel alignment. The rear wheel alignment includes a wheel camber (angle) and individual rear wheel toe in. The front wheel alignment and rear wheel alignment are called four-wheel alignment.

The existing four-wheel aligner measures the relative positions and inclination angles of the tires through measuring components, and then obtains the parameter information of the four tires to analyze the four-wheel alignment information; some of the existing four-wheel aligners clamp the measuring components onto the wheel hub of the tire for measurement operations, which can easily cause damage to the wheel hub of the tire, and at the same time, the clamping method is not conducive to adjusting the measurement position of the measuring components, so that the adjusting of the measurement position is difficult, and the accuracy of the measurement results is low.

### SUMMARY

An object of the present application is to a four-wheel aligner, so as to solve the technical problems of easily damaging tires, difficult measurement position adjustment, and low measurement accuracy of the four-wheel aligner in the art.

In order to solve above object, the technical solution adopted in the present application is summarized as following:

In a first aspect, a four-wheel aligner is proposed, which includes: four four-wheel alignment and measuring devices and two four-wheel alignment and calibration devices;

the four four-wheel alignment and measuring devices are configured to be placed one by one corresponding to sides of the four tires of a vehicle to be aligned, one of the two four-wheel alignment and calibration devices is arranged between two of the four four-wheel alignment and measuring devices located at a side of the vehicle to be aligned, another one of the two four-wheel alignment and calibration devices is arranged between another two of the four four-wheel alignment and measuring devices located at another side of the vehicle to be aligned, and the two four-wheel alignment and calibration devices are configured to be oppositely arranged on two sides of the vehicle to be aligned; the four four-wheel alignment and measuring devices are configured to obtain images of the tires and to analyze alignment information of the tires; and one of the two four-wheel alignment and calibration devices is configured to calibrate calibrate two four-wheel alignment and measuring devices located at a same side of the one of the two four-wheel alignment and calibration devices and another one of the two four-wheel alignment and calibration devices on an opposite side.

By adopting the above technical solution:

The four-wheel alignment and measuring devices correspond one-to-one with the four tires of the vehicle to obtain alignment information of the tires by obtaining tire images. In this way, the four-wheel alignment and measuring devices obtain the alignment information of the tires in a non-contact measurement method, the damage to the tires can be avoided, and the convenience of adjusting the four-wheel alignment and measuring devices and four-wheel alignment and calibration devices can be improved; in addition, one four-wheel alignment and calibration device can calibrate two four-wheel alignment and measuring devices located on the same side of the vehicle and the four-wheel alignment and calibration device on the opposite side, the accuracy of calibrating their own positions can be improved and the number of four-wheel alignment and calibration devices can be saved.

In an embodiment, the four-wheel aligner further includes a user terminal configured to communicate with the four four-wheel alignment and measuring devices and the two four-wheel alignment and calibration devices, and the user terminal is configured to receive, display and transmit measurement information obtained by the four four-wheel alignment and measuring devices and calibration information obtained by the two four-wheel alignment and calibration devices.

In an embodiment, the four-wheel aligner further includes a plurality of fixing members arranged at the four four-wheel alignment and measuring devices and the two four-wheel alignment and calibration devices, and the plurality of fixing members are configured to be fixedly connected to a lifting machine for carrying the vehicle.

In an embodiment, the plurality of fixing members are magnetic members capable of being magnetically fixed to the lifting machine for carrying the vehicle.

In an embodiment, each of the four four-wheel alignment and measuring devices includes a support seat, a support rod connected with an end of the support seat, a laser device, and a first photographic device arranged on the support rod; a length direction of the support rod is inclined to a length direction of the support seat, the laser device is configured to project a laser image onto a surface of each tire, and the first photographic device is configured to obtain the laser image and obtain the alignment information of the tire based on the laser image.

In an embodiment, the laser device includes a inclined support and a laser module arranged on the inclined support; the inclined support is configured to support the laser module so that a central axis of the laser module is inclined to a plane where a wheel hub of the tire to be measured is located, and the laser module projects the laser image from the inclined support to the surface of the tire.

In an embodiment, each of the four four-wheel alignment and measuring devices further comprises a second photographic device arranged on the support seat, and the second photographic device is configured to obtain an image of the four-wheel alignment and calibration device to calibrate a position of the four-wheel alignment and calibration device.

In an embodiment, the second photographic device includes a second camera housing arranged on the support seat and a second camera host arranged in the second camera housing; the second camera housing is provided with an accommodating cavity and a second camera opening in communication with the accommodating cavity, the second camera host is arranged in the accommodating cavity, and the second camera host is configured to take images through the second camera opening; and an extension direction of a central axis of the second camera host is inclined to an extension direction of a connecting line between the second photographic device and the four-wheel alignment and calibration device configured to calibrate the second photographic device.

In an embodiment, each of the two four-wheel alignment and calibration devices includes a calibration seat, a calibration component, a third photographic device, and a photographic device connector; the calibration seat is defined to have at least two calibration directions parallel to the calibration seat, the calibration component is arranged on the calibration seat and is located in the calibration direction, an end of the photographic device connector is connected with the calibration seat, and the other end of the photographic device connector is connected with the third photographic device, so that projections of the third photographic device and the calibration component along any of the calibration directions are not coincide with each other.

In an embodiment, the photographic device connector includes a first connection segment and a second connection segment connected with the first connection segment; the first connection segment is configured to connect with the calibration seat, and the first connection segment is arranged along a first direction perpendicular to a side of the calibration seat; the second connection segment is configured to connect with the third photographic device, the second connection segment extends along a second direction perpendicular to the first direction to enable the third photographic device to take images of another calibration seat while avoiding the side of the calibration seat.

### BRIEF DESCRIPTION OF THE DRAWINGS

In order to provide a clearer explanation of the technical solution in the embodiments of the present application, a brief description will be given below to the accompanying drawings required in the embodiments. It is evident that the accompanying drawings described below are only some embodiments of the present application. For those skilled in the art, other accompanying drawings can be obtained based on these drawings without creative labor.

FIG. 1 is a perspective structural view of a four-wheel aligner provided in an embodiment of the present application;

FIG. 2 is a perspective structural view of a four-wheel alignment and measuring device provided in an embodiment of the present application;

FIG. 3 is a perspective structural view of a support seat provided in an embodiment of the present application;

FIG. 4 is an exploded view of a support seat provided in an embodiment of the present application;

FIG. 5 is a perspective structural view of the support rod provided in an embodiment of the present application;

FIG. 6 is a perspective structural view of a first photographic device provided in an embodiment of the present application;

FIG. 7 is an exploded view of a first photographic device provided in an embodiment of the present application;

FIG. 8 is a sectional view of a first photographic device provided in an embodiment of the present application;

FIG. 9 is an exploded view of a laser device provided in an embodiment of the present application; and

FIG. 10 is a perspective structural view of a four-wheel alignment and calibration device provided in an embodiment of the present application.

In the drawings, the reference signs are listed:

1-four wheel alignment and measuring device; 2-four wheel alignment and calibration device; 3-lifting machine; 4-fixing member; 5-second photographic device;

11-support seat; 12-laser device; 12-support rod; 13-laser device; 14-first photographic device; 21-calibration seat; 22-calibration component; 24-third photographic device; 25-photographic device connector; 26-calibration cover; 31-alignment seat; 51-second camera housing; 52-second camera host; 53-second camera opening;

111-support housing; 112-power supply member; 121-first support portion; 122-second support portion; 141-first camera housing; 142-first camera host; 143-first lens; 144-first camera opening; 131-inclined support; 132-laser module; 251-first connection segment; 252-second connection segment; 221-calibration rod;

1111-first connecting end; 1112-second connecting end; and 1441-convex and transparent surface.

### DETAILED DESCRIPTION OF EMBODIMENTS

In order to make the purpose, the technical solution and the advantages of the present application be clearer and more understandable, the present application will be further described in detail below with reference to accompanying figures and embodiments. It should be understood that the specific embodiments described herein are merely intended to illustrate but not to limit the present application.

It is noted that when a component is referred to as being “fixed to” or “disposed on” another component, it can be directly or indirectly on another component. When a component is referred to as being “connected to” another component, it can be directly or indirectly connected to another component.

In the description of the present application, it needs to be understood that, directions or location relationships indicated by terms such as “length”, “width”, “up”, “down”, “front”, “rear”, “left”, “right”, “vertical”, “horizontal”, “top”, “bottom”, “inside”, “outside”, and so on are the directions or location relationships shown in the accompanying figures, which are only intended to describe the present application conveniently and simplify the description, but not to indicate or imply that an indicated device or component must have specific locations or be constructed and manipulated according to specific locations; therefore, these terms shouldn't be considered as any limitation to the present application.

In addition, the terms “first” and “second” are only used to describe the purpose and cannot be understood as indicating relative importance or indicating the quantity of technical features. In the description of the present application, “a plurality of” means two or more, unless otherwise specified. The following will provide a more detailed description of the specific implementation of the present application in conjunction with specific embodiments.

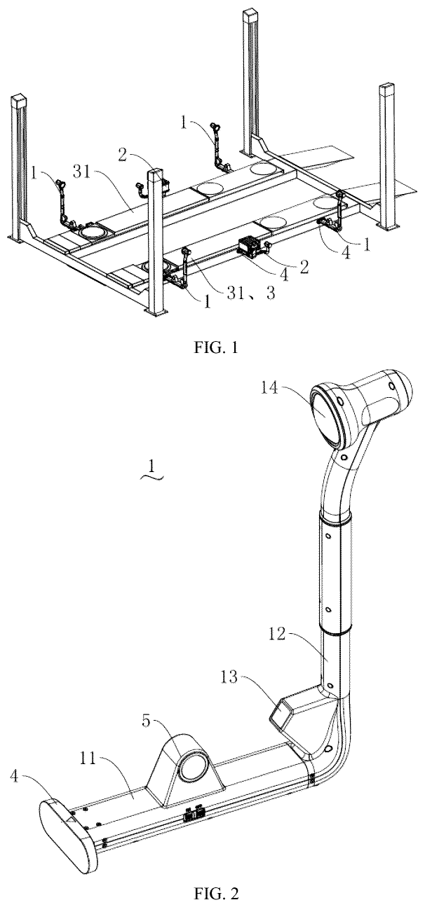

As shown in FIG. 1, an embodiment of the present application provides a four-wheel aligner, which includes:

Four four-wheel alignment and measuring devices 1 and two four-wheel alignment and calibration devices 2; the four four-wheel alignment and measuring devices 1 are configured to be placed one by one corresponding to sides of the four tires of a vehicle to be aligned, one of the two four-wheel alignment and calibration devices 2 is arranged between two of the four four-wheel alignment and measuring devices 1 located at a side of the vehicle to be aligned, another one of the two four-wheel alignment and calibration devices 2 is arranged between another two of the four four-wheel alignment and measuring devices 1 located at another side of the vehicle to be aligned, and the two four-wheel alignment and calibration devices 2 are configured to be oppositely arranged on two sides of the vehicle to be aligned; the four four-wheel alignment and measuring devices 1 are configured to obtain images of the tires and to analyze alignment information of the tires; and one of the two four-wheel alignment and calibration devices 2 is configured to calibrate the four-wheel alignment and measuring devices 1 and the another one of the two four-wheel alignment and calibration devices 2 on an opposite side.

The working principle of the four-wheel aligner provided in this embodiment is as follows:

The four-wheel aligner of the embodiment is explained by arranging a lifting machine 3 for carrying the vehicle, and the lifting machine 3 includes an alignment seat 31. When the vehicle enters the interior of the lifting machine 3 for carrying the vehicle, the alignment seat 31 is configured to support the tires of the vehicle. Here, it can be understood that the alignment seat 31 is configured to support the tires of the vehicle; the alignment seat 31 has a certain length and can be used to support both the front and rear wheels on the same side of the vehicle. Therefore, two alignment seats 31 can be provided, that is, two alignment seats 31 are spaced apart and correspond to the front and rear wheels on both sides of the vehicle; the lifting machine 3 for carrying the vehicle is provided with a positioning space for the vehicle to enter. When the vehicle enters the positioning space, the front and rear wheels of the vehicle can just stay on the alignment seats 31, that is, the front and rear wheels of the vehicle can stay on the same alignment seat 31 at the same time.

For example, the alignment seat 31 can be made of magnetic material, which makes the alignment seat 31 magnetic and facilitates the magnetic attachment of the four-wheel alignment and calibration devices 2 and the four-wheel alignment and measuring devices 1 onto the alignment seat 31. For example, the alignment seat 31 can be made of magnetic metal, so that the entire alignment seat 31 is magnetic. The four-wheel alignment and calibration devices 2 and the four-wheel alignment and measuring devices 1 can magnetically attach to any position of the alignment seat 31, or same parts of the alignment seat 31 are magnetic parts, so that the parts are magnetic. The four-wheel alignment and calibration devices 2 and the four-wheel alignment and measuring devices 1 can magnetically attach to any position of the magnetic parts of the alignment seat 31.

The four-wheel alignment and measuring devices 1 can be located on the side of the tire, that is, the four-wheel alignment and measuring devices 1 are facing the wheel hubs of the tires. The four-wheel alignment and measuring devices 1 can be magnetically attached to any position of the alignment seat 31. The four-wheel alignment and measuring devices 1 are configured to obtain the alignment information of the tires. The four-wheel alignment and measuring devices 1 can adjust the positions on the alignment seat 31 to align with the tires and perform measurement operations. At the same time, the four-wheel alignment and measuring devices 1 can be fixed at any position on the alignment seat 31 to adapt to the measurement of tires for different vehicles.

The four-wheel alignment and calibration devices 2 can magnetically attach to the preset positions of the magnetic parts of the alignment seat 31, and the four-wheel alignment and calibration devices 2 are configured to calibrate the positions of the four-wheel alignment and measuring devices 1. Here, it can be understood that the four-wheel alignment and calibration devices 2 are configured to calibrate the positions of the four-wheel alignment and measuring devices 1, so that the four-wheel alignment and measuring devices 1 are in the correct measurement positions. It needs further explanation that when the four-wheel alignment and calibration devices 2 are fixed at the preset positions, the four-wheel alignment and calibration devices 2 serve as the initial value of the position coordinate system, the four-wheel alignment and measuring devices 1 determines their own positions by obtaining the four-wheel alignment and calibration devices 2 to calibrate whether they are in the correct measurement positions; the preset position of the alignment seat 31 can be a fixed position on the alignment seat 31 or a non fixed position on the alignment seat 31, that is, the preset position can change with the vehicle to be four-wheel aligned.

When the vehicle is driven into the lifting machine 3 for carrying the vehicle, where the front and rear wheels of the vehicle stay on the same alignment seat 31; the four-wheel alignment and calibration devices 2 are arranged at the preset positions of the alignment seat 31, then the tires of the vehicle corresponding to the four-wheel alignment and measuring devices 1 are arranged on the alignment seat 31. The four-wheel alignment and calibration device 2 is located between two four-wheel alignment and measuring devices 1, the four-wheel alignment and measuring devices 1 obtain the calibration information of the four-wheel alignment and calibration device 2, and determine whether the four-wheel alignment and measuring devices 1 are in the correct measurement positions based on the four-wheel alignment and calibration device 2. The four-wheel alignment and calibration devices 2 on opposite sides calibrate their positions with each other, when the four-wheel alignment and measuring devices 1 identify that the four-wheel alignment and measuring devices 1 are in the correct measurement positions, the alignment measurement for the tires is carried out.

By adopting the above technical solution:

The four-wheel alignment and measuring devices 1 correspond one-to-one with the four tires of the vehicle to obtain alignment information of the tires by obtaining tire images. In this way, the four-wheel alignment and measuring devices 1 obtain the alignment information of the tires in a non-contact measurement method, the damage to the tires can be avoided, and the convenience of adjusting the four-wheel alignment and measuring devices 1 and four-wheel alignment and calibration devices 2 can be improved; in addition, one four-wheel alignment and calibration device 2 can calibrate two four-wheel alignment and measuring devices 1 located on the same side of the vehicle and the four-wheel alignment and calibration device 2 on the opposite side, the accuracy of calibrating their own positions can be improved and the number of four-wheel alignment and calibration devices 2 can be saved.

In an embodiment, the four-wheel aligner further includes a user terminal, which is configured to communicate with the four-wheel alignment and measuring devices 1 and the four-wheel alignment and calibration devices 2. The user terminal is configured to receive, display and transmit measurement information obtained by the four four-wheel alignment and measuring devices 1 and calibration information obtained by the two four-wheel alignment and calibration devices 2.

Here, it can be understood that the user terminal is provided with a communication device connected to the four-wheel alignment and measuring devices 1 and the four-wheel alignment and calibration devices 2. The communication device includes but is not limited to a wireless communication connection device, and the wireless communication methods include but are not limited to Wi-Fi wireless connection and Bluetooth wireless connection; the user terminal is further provided with a display device for displaying measurement information and calibration information. Similarly, the four-wheel alignment and measuring devices 1 and the four-wheel alignment and calibration devices 2 also have communication devices connected to the user terminals.

By adopting the above technical solution, the measurement and calibration information of the four-wheel alignment and measuring devices 1 and the four-wheel alignment and calibration devices 2 are all collected on the user terminal for unified analysis, display, and external dissemination.

In an embodiment, the four-wheel aligner further includes a plurality of fixing members 4, which are arranged on the four-wheel alignment and measuring devices 1 and the four-wheel alignment and calibration devices 2, and the fixing members 4 are fixedly connected to the lifting machine 3 for carrying the vehicle.

Here, it can be understood that fixing members 4 include but are not limited to a magnetic member and a snap-fit fastener.

By adopting the above technical solution, the fixed connection between the four-wheel alignment and measuring devices 1 and the four-wheel alignment and calibration devices 2 and the lifting machine 3 can be achieved.

In an embodiment, the fixing member 4 is a magnetic member that can be magnetically attached to the lifting machine 3 for carrying the vehicle.

By adopting the above technical solution, the fixed connection by magnetic attachment between the four-wheel alignment and measuring devices 1 and the four-wheel alignment and calibration devices 2 and the lifting machine 3 is achieved.

As shown in FIG. 2 together, in an embodiment, each of the four-wheel alignment and measuring devices 1 includes a support seat 11, a support rod 12, a laser device 13, and a first photographic device 14 arranged on the support rod 12; a length direction of the support rod 12 is inclined to a length direction of the support seat 11, the fixing member 4 is fixed by using the four-wheel alignment and measuring devices 1, the laser device 13 is configured to project a laser image onto a surface of each tire, and the first photographic device 14 is configured to obtain the laser image and obtain the alignment information of the tire based on the laser image.

Here, it can be understood that the support rod 12 is configured to support the first photographic device 14, so that when the four-wheel alignment and measuring devices 1 are fixed on the lifting machine 3 for carrying the vehicle, the laser device 13 and the first photographic device 14 are in the correct measurement position; optionally, the laser device 13 is arranged on the support seat 11 or the support rod 12, the laser device 13 is configured to project laser towards the tire, and the laser forms a laser image on the surface of the tire. The first photographic device 14 is arranged on the support rod 12, the first photographic device 14 configured to capture the laser image on the surface of the tire, to analyze the laser image, and to finally obtain the alignment information of the tire. The laser device 13 can be selected as a laser projection device, the laser projection device projects a plurality of lasers towards the surface of the tire to form laser spots on the surface of the tire, to form the laser image. The first photographic device 14 can be selected as the first photographic device 14, which captures a plurality of laser spots. By analyzing the length, spacing, deformation and other data of the plurality of laser spots, the alignment information of the tire, such as the inclination angle of the tire, is finally obtained. It should be further explained that the length direction of the support rod 12 is inclined to the length direction of the support seat 11, and the support seat 11 is configured to fix the entire four-wheel alignment and measuring device 1. In the embodiment, one end of the support seat 11 is connected to the lifting machine 3 for carrying the vehicle, that is, the support seat 11 is arranged close to the tire, and the support rod 12 is obliquely arranged to allow the first photographic device 14 to be close to the tire, so that the first photographic device 14 can obtain clear laser images; at the same time, the center of gravity of the first photographic device 14 can also close to the tire, and the entire four-wheel alignment and measuring device 1 can be avoided from inclining due to the excessive weight of the first photographic device 14. In addition, when the laser device 13 is mounted onto the support seat 11, this design leaves a certain distance between the laser device 13 and the tire, the projection range of the laser device 13 is ensured, and significant distortion of the laser image projected on the surface of the tire can be avoided; thus the clarity of the laser image is improved, and the identification accuracy of the first photographic device 14 is improved. This design takes into account the fact that the center of gravity of the laser device 13 is as close as possible to the tire, and the possibility of inclining of the four-wheel alignment and measuring device 1 is reduced; in addition, this design reduces the angle between the laser image projected by the laser device 13 and the first photographic device 14, and the identification difficulty of the first photographic device 14 is reduced.

The working principle of the four-wheel alignment and measuring device 1 provided in the embodiment is summarized as following:

The vehicle stays on the lifting machine 3 for carrying the vehicle, the four-wheel alignment and measuring devices 1 are mounted on the lifting machine 3 for carrying the vehicle and are arranged close to the tires; specifically, the position of the fixing member 4 can be adjusted so that the laser device 13 and the first photographic device 14 can be located in the correct measurement position. The laser device 13 is started to form the laser image on the surface of the tire, and then the laser image is captured by the first photographic device 14 to analyze and obtain the alignment information of the tire.

By adopting the above technical solution: a first inclination angle is formed between the length direction of the support seat 11 and the length direction of the support rod 12. This design takes into account the projection range of the laser device 13, the center of gravity of the laser device 13 being arranged close to the tire, and the angle between the laser image projected by the laser device 13 and the first photographic device 14, the accuracy of the measurement results is improved, the possibility of overturning of the four-wheel alignment and measuring devices 1 is reduced, and the protective performance is enhanced.

In an embodiment, the inclination angle is ranged from 45° to 90°.

Optionally, the inclination angle is 45°, 60°, 75°, or 90°.

Preferably, the inclination angle is 90°.

By adopting the above technical solution, when the angle of the first inclination angle is 90°, the support rod 12 is perpendicular to the support seat 11, and the center of gravity of the support rod 12 coincides with the central line of the support rod 12. This design leaves a certain distance between the first photographic device 14 and the tire, which ensures that the first photographic device 14 has sufficient acquisition range and also ensures that the center of gravity of the first photographic device 14 is prevented not too far away from the tire to increase the risk of lateral oblique.

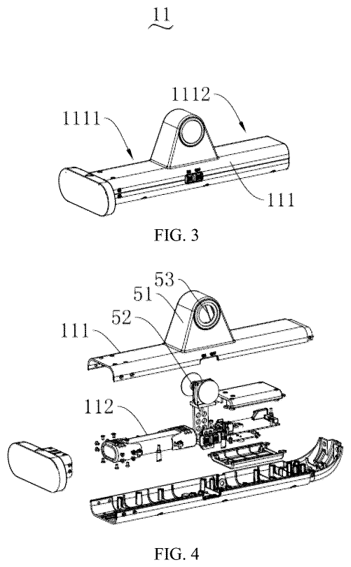

As shown in FIGS. 3 and 4 together. In an embodiment, the support seat 11 includes a support housing 111 and a power supply member 112 located inside the support housing 111; the support housing 111 is provided with a first connecting end 1111 and a second connecting end 1112 along the length direction of the support housing 111. The first connecting end 1111 is configured to fix the four-wheel alignment and measuring device 1, the second connecting end 1112 is configured to connect with the first photographic device 14 and the laser device 13, the power supply member 112 is located inside the support housing 111 at the position of the first connecting end 1111, and the power supply member 112 is configured to electrically connect with the first photographic device 14 and the laser device 13.

Here, it can be understood that the support housing 111 is configured to protect the power supply member 112 inside the support housing 111, so that the power supply member 112 can avoid from being damaged; and the power supply member 112 is configured to supply electrical energy to the first photographic device 14.

Specifically, the support housing 111 is formed with the first connecting end 1111 and the second connecting end 1112, the first connecting end 1111 and the second connecting end 1112 are arranged opposite to each other and located in the length direction of the support housing 111, the first connecting end 1111 is configured to connect with the lifting machine 3 for carrying the vehicle, and the second connecting end 1112 is configured to connect with the first photographic device 14; the power supply member 112 is configured to electrically connect with the first photographic device 14; the weight of the power supply member 112 is relatively large, so that the power supply member is arranged at the first connecting end 1111, and the center of gravity of the entire support seat 11 can be arranged close to the vehicle.

The working principle of the support seat 11 provided in the embodiment is as follows:

The first photographic device 14 is arranged on the second connecting end 1112 of the support seat 11, the first connecting end 1111 of the support seat 11 is then connected to lifting machine 3 for carrying the vehicle; as the support seat 11 has a certain length, the support seat 11 can form a preset distance between the first photographic device 14 and the tire of the vehicle.

By adopting the above technical solution, due to the heavy weight of the power supply member 112, thus the power supply member 112 being arranged at the first connecting end 1111 can cause the center of gravity of the entire support seat 11 to lean towards the vehicle. In addition, since the power supply member 112, the first photographic device 14 and the laser device 13 are respectively located at opposite ends of the support seat 11, thus the power supply member 112 balances the influence of the gravity of the first photographic device 14 and the laser device 13 on the support seat 11, the tilting possibility of the support seat 11 is reduced, and the possibility of damage to the first photographic device 14 and the laser device 13 is reduced.

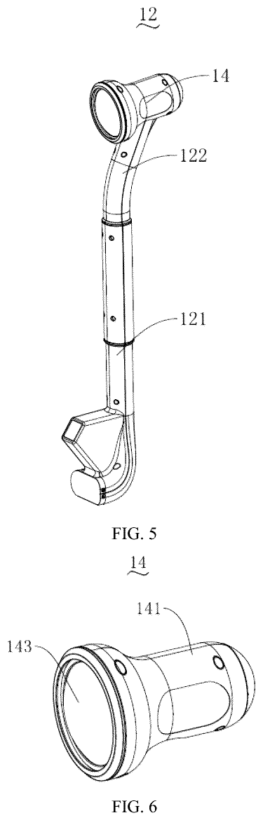

As shown in FIG. 5, in an embodiment, the support rod 12 includes a first support portion 121 and a second support portion 122 connected to the first support portion 121; the first support portion 121 is configured to fix the four-wheel alignment and measuring device 1; the second support portion 122 is configured to connect with the first photographic device 14, the second support portion 122 extends from the first support portion 121 in a direction away from the tire, and a portion of the second support portion 122 away from the first support portion 121 is configured to support the first photographic device 14.

Here, it can be understood that the first support portion 121 is configured to connect with the lifting machine 3 for carrying the vehicle; and the second support portion 122 is configured to connect with the first photographic device 14.

Specifically, the first support portion 121 is connected to the second support portion 122 and the lifting machine 3 for carrying the vehicle. The first support portion 121 is configured to fix the second support portion 122 relative to the lifting machine 3 for carrying the vehicle, and to provide a certain distance between the second support portion 122 and the tire. The second support portion 122 is connected to the first support portion 121 and the first photographic device 14, and the second support portion 122 is configured to fix the first photographic device 14 relative to the tire and to provide a preset distance between the first photographic device 14 and the tire.

It needs further explanation that when the support rod 12 is connected to the lifting machine 3 for carrying the vehicle, the second support portion 122 extends from the first support portion 121 in a direction away from the vehicle, that is, the second support portion 122 is arranged relative to the first support portion 121 away from the tire of the vehicle, so that the first photographic device 14 on the second support portion 122 can move away from the tire, which ensures a preset distance between the first photographic device 14 and the tire. The first support portion 121 is arranged relatively close to the tire of the vehicle compared to the second support portion 122, so that the center of gravity of the entire support rod 12 is close to the vehicle, the occurrence of tilting caused by the support rod 12 being too far away from the vehicle is reduced.

By adopting the above technical solution, the second support portion 122 extends from the first support portion 121 in a direction away from the vehicle, so that the first photographic device 14 on the second support portion 122 can be arranged away from the tire, which ensures that there is sufficient space to reserve a preset distance between the first photographic device 14 and the tire; at the same time, the first support portion 121 is arranged relatively close to the tire of the vehicle compared to the second support portion 122, so that the center of the entire support rod 12 is positioned close to the tire, the tilting phenomenon caused by the center of gravity of the support rod 12 moving away from the tire is reduced, and the possibility of damage to the first photographic device 14 is reduced.

In an embodiment, when the first support portion 121 is connected to the lifting machine 3 for carrying the vehicle, the length direction of the first support portion 121 is parallel to the vertical direction.

Here, it can be understood that when the vehicle is being detected, the wheel hub of the tire of the vehicle is perpendicular to the ground, that is, the surface of the wheel hub is parallel to the vertical direction. At this time, the length direction of the first support portion 121 is arranged to be parallel to the vertical direction, so that the second support portion 122 can have a certain height when supported by the first support portion 121, this allows the first photographic device 14 located on the second support portion 122 to have a certain height, which is conducive to the correspondence between the first photographic device 14 and the center position of the tire, so that the first photographic device 14 can be in the normal measurement range.

It needs further explanation that the first photographic device 14 is configured to measure the alignment information of the tire, and the first photographic device 14 is configured to capture or emit detection rays to obtain the alignment information of the tire. In the embodiment, the length direction of the first support portion 121 is arranged to be parallel to the vertical direction, which avoids the possibility of the first support portion 121 obstructing the first photographic device 14 and reduces the influence of the first support portion 121 on the measurement results of the first photographic device 14.

By adopting the above technical solution, the first support portion 121 is arranged to be parallel to the vertical direction during the detection of the vehicle, which avoids the possibility of the first support portion 121 obstructing the first photographic device 14 and reduces the impact on the measurement results.

Here, it can be understood that within the above-mentioned inclined angle range, the second support portion 122 can ensure that the first photographic device 14 is sufficiently distant from the tire of the vehicle. Preferably, the inclined angle is 160°.

By adopting the above technical solution, it is ensured that the first photographic device 14 on the second support 122 is sufficiently distant from the tire of the vehicle.

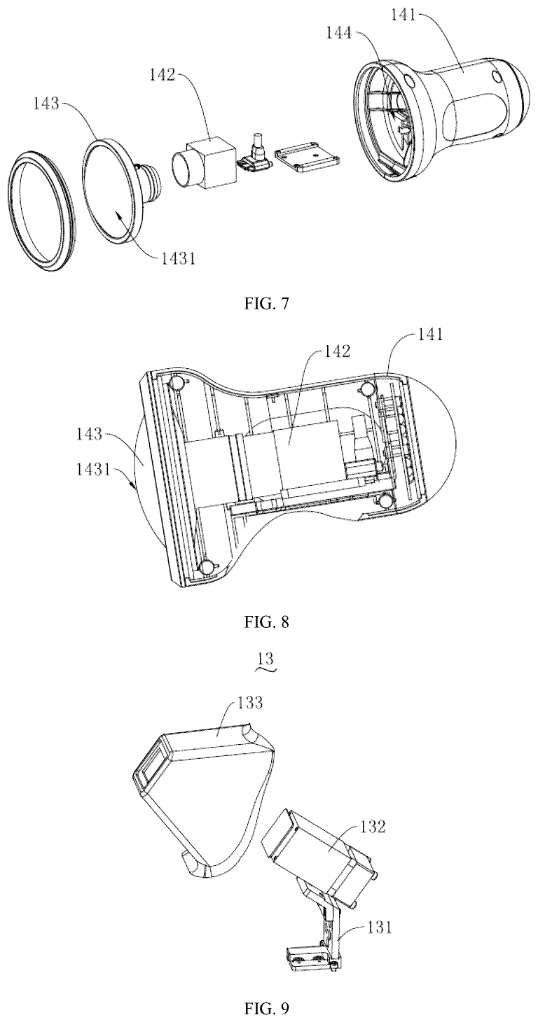

As shown in FIGS. 6 to 8 together, in an embodiment, the first photographic device 14 includes a first camera housing 141, a first camera host 142 located inside the first camera housing 141, and a first lens 143 connected to a camera of the first camera host 142; the first camera housing 141 is provided with an accommodating cavity for accommodating the first camera host 142 and a first camera opening 144 in communication with the accommodating cavity. The first lens 143 is provided in the first camera opening 144, and a side surface of the first lens 143 away from the camera is provided with a convex and transparent surface 1441, and the convex first lens 143 is configured to reduce the focal length of the first camera host 142 and expand the perspective of the first camera host 142.

Here, it can be understood that the first camera housing 141 is configured to protect and support the first camera host 142 and the first lens 143; the first camera host 142 is configured to obtain tire images and analyze the alignment information of the tire; the first lens 143 is configured to adjust the focal length of the first camera host 142, so as to expand the perspective of the first camera host 142 and ensure that a complete image of the surface of the tire can be obtained even when the first camera host 142 is close to the tire.

Specifically, the first camera housing 141 serves as a protective member and a support member. The first camera housing 141 is provided with the accommodating cavity and the first camera opening 144, the accommodating cavity is located inside the first camera housing 141. The first camera opening 144 penetrates through the first camera housing 141 and is in communication with the accommodating cavity; the first camera host 142 is arranged in the accommodating cavity, and the camera of the first camera host 142 is facing the first camera opening 144; the first lens 143 is arranged in the first camera opening 144 and is covered on the camera of the first camera host 142; the first lens 143 is a convex first lens 143, and the convex transparent surface 1441 is provided on the side of the first lens 143 away from the first camera host 142; the convex first lens 143 is configured to reduce the focal length of the first imaging host 142 and expand the perspective of the first imaging host 142.

The working principle of the first photographic device 14 provided in the embodiment is as follows:

The first photographic device 14 is arranged close to the tire, the camera the arranged aligning with the surface of the tire, and the camera captures an image of the tire; since the front side of the camera is provided with the convex first lens 143, such that more reflected light passing through the surface of the tire can enter the convex first lens 143 from the convex transparent surface 1441, and then the reflected light enter the first camera host 142 from the convex first lens 143. That is, the focal length of the first camera host 142 is adjusted, the perspective of the first camera host 142 is increased, and the first camera host 142 can obtain a wider picture. Therefore, the first camera host 142 can obtain a more complete tire image at a closer distance to the tire.

By adopting the above technical solution, it is ensured that the first photographic device 14 can still obtain a more complete tire image even when it is too close to the tire, which improves the amount of image recognition information and recognition accuracy.

In an embodiment, the central axis of the first camera host 142 is inclined at an angle to the length direction of the support seat 11, and the inclined angle is ranged from 0° to 45°.

Here, it can be understood that the first camera host 142 is configured to obtain laser images of the surface of the tire; during the measurement operation, the laser device 13 projects a laser image on the surface of the tire from bottom to top diagonally, and the first camera host 142 captures the laser image of the surface of the tire from top to bottom diagonally.

It needs further explanation that, optionally, the inclined angle can be ranged from 15° or 30°.

By adopting the above technical solution, the first camera host 142 is inclined to facilitate the capturing of laser images.

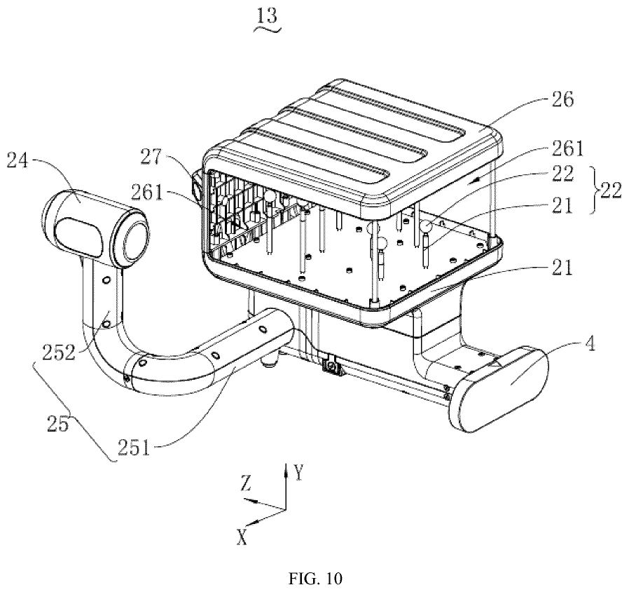

As shown in FIGS. 9 and 10 together, in an embodiment, the laser device 13 includes an inclined support 131 and a laser module 132 located on the inclined support 131; the inclined support 131 is configured to support the laser module 132, so that the central axis of the laser module 132 forms an inclined angle with a plane where the wheel hub of the tire to be measured is located. The laser module 132 is configured to project a laser image towards the surface of the tire to be measured from the inclined support 131.

Here, it can be understood that the inclined support 131 is configured to support the laser module 132, that is, the laser module 132 is supported in a suitable projection position, so that the laser image projected by the laser module 132 can cover the surface of the tire to be measured. The laser module 132 is fixed relative to the tire to be measured in an inclined state, that is, when the inclined support 131 supports the laser module 132, the central axis of the laser module 132 is inclined to the plane where the wheel hub of the tire to be measured is located; the laser module 132 is configured to project laser images towards the surface of the tested tire. The first photographic device 14 obtains the laser image and analyzes the alignment information of the tire based on the deformation and spacing of the laser image.

Specifically, the laser module 132 is mounted on the inclined support 131 and is configured to project laser images towards the surface of the tire, so that a laser image is formed on the surface of the tire; the first photographic device 14 is configured to capture the laser image of the surface of the tire and analyze the laser image, and the alignment information of the tire is finally obtained. The laser module 132 can project multiple lasers towards the surface of the tire to form laser spots on the surface of the tire, that is, to form the laser image. The first photographic device 14 captures multiple laser spots and analyzes the length, spacing, deformation, and other data of the multiple laser spots to ultimately obtain the alignment information of the tire, such as the inclined angle of the tire; the laser module 132 is inclined under the support of the inclined support 131, that is, the laser module 132 forms an inclined angle with the plane where the wheel hub of the tire to be measured is located, that is, the laser device 13 projects the laser obliquely, such that the projection distance of the laser module can be ensured while leaves a small distance between the laser module 132 and the tire, and allows the laser to cover the surface of the tire; the projection range of the laser is increased, significant distortion of the laser image projected on the surface of the tire can be avoided, the clarity of the laser image is improved, and the recognition accuracy of the first photographic device 14 is improved. In addition, this design takes into account the fact that the center of gravity of the laser module 132 is as close as possible to the tire, the possibility of tilting of the four-wheel alignment and measuring device 1 is reduced. Further, this design reduces the recognition difficulty of the first photographic device 14 and improves the accuracy of the detection results of the vehicle detection device.

By adopting the above technical solution, while ensuring the miniaturization of vehicle detection device and the small distance between the laser device 13 and the tire, the laser image projected by the laser device 13 covers the surface of the tire, and the recognition accuracy of the laser image is improved, that is, the accuracy of the detection results of the vehicle detection device is improved.

In one embodiment, the inclined angle is ranged from 0° to 60°.

Here, it can be understood that during the four-wheel alignment and measuring operation, the laser device 13 is arranged on the side of the wheel hub directly facing the tire to be measured, and is located diagonally below the wheel hub; the laser device is configured to project a laser image on the surface of the tire to be measured from bottom to top diagonally. At this time, the central axis of the laser element forms an inclined angle with the plane where the wheel hub of the tire to be measured is located, and the inclined angle is ranged from 0° to 60°; the laser device projects the laser image onto the surface of the tire to be measured at the above-mentioned inclined angle, the coverage range of the laser image on the tire is expanded, thereby the clarity of the laser image obtained by the first photographic device 14 is improved, and thus the accuracy of the detection results of the vehicle detection equipment is improved.

Optionally, the inclined angle is selected from a group of 15°, 30°, or 45°.

By adopting the above technical solution, the coverage range of laser image on the tire is expanded, thereby the clarity of the laser image obtained by the first photographic device 14 is improved, and thus the accuracy of the detection results of the vehicle detection device is improved.

In an embodiment, the four-wheel alignment and measuring device 1 further includes a second photographic device 5 located on the support seat 11, which is configured to obtain images of the four-wheel alignment and calibration device 2 to calibrate the position of the four-wheel alignment and calibration device 2.

As shown in FIGS. 2 to 4 again, in an embodiment, the second photographic device 5 includes: a second camera housing 51 provided on the support seat 11 and a second camera host 52 provided in the second camera housing 51; the second camera housing 51 is provided with an accommodating cavity and a second camera opening 53 in communication with the accommodating cavity. The second camera host 52 is located in the accommodating cavity, and the second camera host 52 is configured to capture images through the second camera opening 53. The extension direction of the central axis of the second camera host 52 and the extension direction of the connecting line between the second photographic device 5 and the four-wheel alignment and calibration device 2 used to calibrate the second photographic device 5 are inclined.

By adopting the above technical solution, the structure of the second photographic device 5 is simple and highly reliable.

As shown in FIG. 10 together, in an embodiment, the four-wheel alignment and calibration device 2 includes a calibration seat 21, a calibration component 22, a third photographic device 24, and a photographic device connector 25. The calibration seat 21 defines at least two calibration directions parallel to the calibration seat 21, and the calibration component 22 is located on the calibration seat 21 and in the calibration direction. One end of the photographic device connector 25 is connected to the calibration seat 21, and the other end of the photographic device connector 25 is connected to the third photographic device 24, so that the projections of the third photographic device 24 and the calibration component 22 along any calibration direction are not coincide with each other.

Here, it can be understood that the calibration seat 21 is configured to support the calibration component 22; the calibration component 22 is configured to provide calibration images for calibrating the positions of the four-wheel alignment and measuring device 1 and the four-wheel alignment and calibration device 2 on the opposite side; the third photographic device 24 is configured to obtain images of the four-wheel alignment and calibration device 2 on the opposite side; and the photographic device connector 25 is configured to connect the third photographic device 24 and the calibration seat 21.

Optionally, the calibration component 22 is located on the calibration seat 21, with a preset distance between the calibration seat 21 and the four-wheel alignment and measuring device 1. This facilitates the four-wheel alignment and measuring device 1 to obtain images of the calibration component 22 on the calibration seat 21, and also facilitates the four-wheel alignment and measuring device 1 to calculate coordinate values based on the distance between the calibration seat 21 and the calibration seat 21. The calibration seat 21 defines at least two calibration directions, which are parallel to the calibration seat 21; specifically, this refers to that the calibration directions being parallel to the surface used to support the calibration component 22 of the calibration seat 21. The four-wheel alignment and measuring device 1 and the four-wheel alignment and calibration device 2 are both located in one of the calibration directions, that is, the four-wheel alignment and measuring device 1 can obtain the image of the four-wheel alignment and calibration device 2 in the calibration direction, which is the calibration image. That is, the four-wheel alignment and measuring device 1 can obtain the image of the calibration component 22 along the calibration direction, so as to analyze the position of the four-wheel alignment and measuring device 1, and then calibrate the position of the four-wheel alignment and measuring device 1. Similarly, the four-wheel alignment and calibration device 2 and the four-wheel alignment and calibration device 2 located on the opposite side are both located in the other calibration direction. That is, the four-wheel alignment and calibration device 2 on the opposite side can obtain the image of the four-wheel alignment and calibration device 2 in the calibration direction, which is the calibration image. That is, the four-wheel alignment and calibration device 2 can obtain the image of the calibration component 22 along the calibration direction, so as to analyze the position of the four-wheel alignment and calibration device 2, and then calibrate the position of the four-wheel alignment and calibration device 2.

By adopting the above technical solution:

The plurality of four-wheel alignment and measuring devices 1 of the four-wheel aligner can obtain calibration images of the calibration component 22 from different calibration directions, so that the plurality of four-wheel alignment and measuring devices 1 can share a same four-wheel alignment and calibration device 2 for calibration operations, the requirement for four-wheel alignment and calibration devices 2 is reduced and the calibration efficiency is improved. At the same time, the calibration seat 21 forms at least two calibration directions, which can also improve the accuracy of calibration results.

One end of the photographic device connector 25 is connected to the side or bottom of the calibration seat 21, and the other end of the photographic device connector 25 is connected to the side or bottom of the third photographic device 24, so that the projections of the third photographic device 24 and the calibration component 22 along any calibration direction are not coincide with each other, so that the third photographic device 24 can avoid the calibration component 22 and reduce the possibility of the third photographic device 24 obstructing the calibration component 22; and the photographic device connector 25 is applied to the four-wheel aligner can reduce the possibility of calibration errors and improve the accuracy of the detection results of the four-wheel aligner.

In an embodiment, the photographic device connector 25 includes a first connection segment 251 and a second connection segment 252 connected to the first connection segment 251; and the first connection segment 251 is configured to connect with the calibration seat 21. The first connection segment 251 extends along the first direction X perpendicular to the side of the calibration seat 21, and at this time, the first direction X is parallel to one of the calibration directions. The second connection segment 252 is configured to connect with the third photographic device 24, and the second connection segment 252 extends along the second direction Y perpendicular to the first direction X, such that the third photographic device 24 is allowed to capture another calibration seat 21 while avoiding the side of the calibration seat 21.

Here, it can be understood that the first connection segment 251 is configured to connect to the calibration seat 21, the second connection segment 252 is configured to connect to the third photographic device 24, and the second connection segment 252 is connected to the first connection segment 251, so that the third photographic device 24 is connected to the calibration seat 21;

Specifically, the first connection segment 251 is connected to the second connection segment 252, the first connection segment 251 is connected to the calibration seat 21, and the first connection segment 251 extends along the first direction X; the second connection segment 252 is connected to the third photographic device 24, and the second connection segment 252 extends along the second direction Y, where the second direction Y is perpendicular to the first direction X. Due to the first connection segment 251 is connected to the calibration seat 21 and extending along the first direction X, that is, the second connection segment 252 connected to the first connection segment 251 and the calibration seat 21 can be separated by an equal distance of the first connection segment 251 in the first direction X, and due to the third photographic device 24 connected to the second connection section 252, which extends along the second direction Y, the third photographic device 24 and the first connection section 251 can be separated by an equal distance in the second direction Y from the second connection section 252. Therefore, the arranging of the first connection segment 251 and the second connection segment 252 allows the third photographic device 24 to be separated from the calibration seat 21 by a preset distance in both the first direction X and the second direction Y, the possibility of the third photographic device 24 obstructing the calibration seat 21 is reduced.

By adopting the above technical solution, the photographic device connector 25 includes the first connection segment 251 and the second connection segment 252 connected to the first connection segment 251. The first connection segment 251 extends in the first direction X, and the second connection segment 252 extends in the second direction Y perpendicular to the first direction X. This allows the third photographic device 24 on the second connection segment 252 to avoid the calibration seat 21 on the first connection segment 251, the possibility of the third photographic device 24 obstructing the calibration seat 21 is reduced; and the photographic device connector 25 being applied to the four-wheel aligner can reduce the possibility of calibration errors and improve the accuracy of the detection results of the four-wheel aligner.

In an embodiment, the four-wheel alignment and calibration device 2 further includes a plurality of calibration components 22, which are located on the calibration seat 21. The projections of the plurality of calibration components 22 along the calibration direction are not coincide with each other, and the heights of the plurality of calibration components 22 on the calibration seat 21 are not the same.

Here, it can be understood that the calibration seat 21 is configured to support the calibration components 22; the calibration components 22 are configured for the four-wheel alignment and measuring device 1 to obtain calibration images. The four-wheel alignment and measuring device 1 analyzes the calibration images to obtain coordinate information, and then calibrates the position of the four-wheel alignment and measuring device 1.

Specifically, the plurality of calibration components 22 are mounted on the calibration seat 21, and a preset distance is left between the calibration seat 21 and the four-wheel alignment and measuring device 1. This facilitates the four-wheel alignment and measuring device 1 to obtain images of the plurality of calibration components 22 on the calibration seat 21, and also facilitates the four-wheel alignment and measuring device 1 to calculate coordinate values based on the distance between the calibration seat 21 and the four-wheel alignment and measuring device 1. The calibration seat 21 defines at least two calibration directions, which are parallel to the calibration seat 21, specifically, this refers to that the calibration directions are parallel to the surface used to support the calibration component 22 of the calibration seat 21. The four-wheel alignment and measuring device 1 and the four-wheel alignment and calibration device 2 are both located in the calibration direction, which means that the four-wheel alignment and measuring device 1 can obtain the image of the four-wheel alignment and calibration device 2 in the calibration direction, this image is the calibration image, which means that the four-wheel alignment and measuring device 1 can obtain the image of the calibration component 22 along the calibration direction. The calibration seat 21 defines at least two calibration directions, that is, at least two four-wheel alignment and measuring devices 1 can simultaneously obtain images of calibration components 22, at the same time, the projections of the plurality of calibration components 22 are not coincide with each other along the calibration direction, and the heights of the plurality of calibration components 22 are not the same. This enables the four-wheel alignment and measuring device 1 to simultaneously obtain images of the plurality of calibration components 22 with different heights. The images of the plurality of calibration components 22 can provide more coordinate values for mutual calibration, thereby the accuracy of calibration results and the accuracy of tire alignment information detected by the four-wheel alignment and measuring device 1 are improved.

It needs further explanation that the number of calibration components 22 is positively correlated with the accuracy of the four-wheel alignment and measuring device 1 in determining its own position. That is, the more calibration components 22 there are, the more images of calibration components 22 obtained by the four-wheel alignment and measuring device 1, and the more accurate the position it can analyze. Specifically, the height of each calibration component 22 is different, and the position of each calibration ball is different, which allows the four-wheel alignment and measuring device 1 to obtain the position coordinates of different calibration components 22. Therefore, the four-wheel alignment and measuring device 1 is allowed to simultaneously obtain different data from the plurality of calibration components 22, and the accuracy of position analysis is increased.

By adopting the above technical solution, a plurality of four-wheel alignment and measuring devices 1 of the four-wheel aligner can obtain calibration images of calibration components 22 from different calibration directions, so that the plurality of four-wheel alignment and measuring devices 1 can share one four-wheel alignment and calibration device 2 for calibration operations, the requirement for four-wheel alignment and calibration device 2 is reduced and the calibration efficiency is improved. At the same time, the calibration seat 21 forms at least two calibration directions, which can also improve the accuracy of calibration results; and the projections of the plurality of calibration components 22 on the calibration seat 21 are not coincide with each other along the calibration direction, this allows the four-wheel alignment and measuring device 1 to obtain images of the plurality of calibration components 22 in the calibration direction. The images of the plurality of calibration components 22 can provide more coordinate values for mutual calibration, thereby the accuracy of the calibration results and the accuracy of the tire alignment information detected by the four-wheel alignment and measuring device 1 are improved.

As shown in FIG. 3 together, in an embodiment, the calibration component 22 includes a calibration rod 221 and a calibration ball 222 located on the calibration rod 221. The calibration rod 221 is vertically mounted on the calibration seat 21, and the calibration ball 222 is located at the end of the calibration rod 221 away from the calibration seat 21.

Here, it can be understood that the calibration rod 221 is configured to support the calibration ball 222, and the calibration ball 222 is used for obtaining images for the four-wheel alignment and measuring device 1;

Specifically, the calibration rod 221 is vertically mounted on the calibration seat 21, that is, the calibration rod 221 is vertically mounted on the calibration seat 21. The calibration ball 222 is used for the four-wheel alignment and measuring device 1 to obtain images. The four-wheel alignment and measuring device 1 takes images of the calibration ball 222 and determines the coordinate values based on the center of the calibration ball 222, so as to calibrate the position of the four-wheel alignment and measuring device 1. The calibration rod 221 is configured to fix the calibration ball 222 at a preset height, so that the four-wheel alignment and measuring device 1 can obtain the calibration ball 222 at the preset height, which is beneficial for the four-wheel alignment and measuring device 1 to determine the coordinate value.

Optionally, the shape of the calibration ball 222 is a sphere, and the camera of the four-wheel alignment and measuring device 1 can calculate the center of the calibration ball 222 from the side or front of the calibration ball 222. When calibrating the four-wheel alignment and measuring device 1, images of the calibration ball 222 need to be obtained from different calibration directions, that is, the images of the calibration ball 222 obtained from different angles are all circular patterns.

The working principle of the calibration component 22 in the embodiment is as follows:

The calibration component 22 is fixed close to the vehicle, for example, the calibration component 22 is fixed between two four-wheel alignment and measuring devices 1 that correspond one-to-one to the tires. The calibration rod 221 has a preset height, and the calibration rod 221 supports the calibration ball 222 so that the calibration ball 222 is located at the preset height. The four-wheel alignment and measuring device 1 is configured to obtain the image of the calibration ball 222, which is circular. The four-wheel alignment and measuring device 1 analyzes the center of the image of the calibration ball 222 and to analyze the coordinate values based on the center of the image, thereby the position of the four-wheel alignment and measuring device 1 itself is calibrated.

It needs further explanation that the four-wheel alignment and measuring device 1 can capture images of the calibration ball 222 from a plurality of calibration directions, because no matter which calibration direction the image of the calibration ball 222 is taken from, the image of the calibration ball 222 is always circular, and its center position remains unchanged. Therefore, the calibration ball 222 in the embodiment can be used to calibrate the four-wheel alignment and measuring device 1 in a plurality of directions.

By adopting the above technical solution, only one calibration component 22 needs to be arranged to complete the calibration operation of the four-wheel alignment and measuring device 1 in a plurality of directions, the consistency of the calibration results is improved and the error of the calibration results is reduced.

In an embodiment, each calibration rod 221 has a different length.

Here, it can be understood that the calibration rod 221 is configured to support the calibration ball 222, and the calibration ball 222 is used for the four-wheel alignment and measuring device 1 to obtain images.

Specifically, the height of each calibration rod 221 is different, so that the calibration ball 222 arranged on the calibration rod 221 has a different height relative to the calibration seat 21.

By adopting the above technical solution, each calibration component 22 has achieved a different height.

In an embodiment, the four-wheel alignment and calibration device 2 further includes a calibration cover 26, which is located above the calibration seat 21. A calibration space is formed between the calibration cover 26 and the calibration seat 21, and at least two calibration openings 261 are formed in the calibration space. The opening direction of the calibration opening 261 is in the same direction as the calibration direction, and the calibration seat 21 is located within the calibration space. The calibration opening 261 is configured to expose the calibration component 22.

Here, it can be understood that the calibration cover 26 is configured to protect the calibration component 22.

Specifically, the calibration cover 26 is located above the calibration seat 21, and the calibration space is formed between the calibration cover 26 and the calibration seat 21. The calibration space forms a calibration opening 261, and the opening direction of the calibration opening 261 is consistent with the calibration direction. The calibration space is provided with the calibration seat 21, and the calibration opening 261 is configured to expose the calibration components 22 in the calibration space.

By adopting the above technical solution, the calibration space is formed between the calibration cover 26 and the calibration seat 21 to accommodate the calibration component 22, the protective performance of the calibration component 22 is improved. At the same time, the calibration space forms the calibration opening 261 for exposing the calibration component 22.

In an embodiment, the four-wheel alignment and calibration device 2 further includes a calibration side cover 27, which is configured to connect the calibration cover 26 and the calibration seat 21, so that three calibration openings 261 are formed in the calibration space.

Here, it can be understood that the calibration side cover 27, the calibration cover 26, and the calibration seat 21 are enclosed to form the calibration space, and form calibration openings 261 in communication with the calibration space, the calibration openings 261 correspond to three different calibration directions.

In the embodiment, the four-wheel aligner includes the lifting machine 3 for carrying the vehicle, four four-wheel alignment and measuring devices 1, and two four-wheel alignment and calibration devices 2. Two four-wheel alignment and measuring devices 1 are located on one side of the lifting machine 3 for carrying the vehicle, corresponding to the front and rear wheels on one side of the vehicle. One four-wheel alignment and calibration device 2 is arranged between the two four-wheel alignment and measuring devices 1. The two four-wheel alignment and measuring devices 1 are configured to obtain calibration images of the calibration component 22 of the four-wheel alignment and calibration device 2 to calibrate the two four-wheel alignment and measuring devices 1. Therefore, the two calibration openings 261 in the three calibration openings 261 of each of the two four-wheel alignment and calibration devices 2 need to face different directions to correspond to the calibration of the two four-wheel alignment and measuring devices 1. Similarly, the other two four-wheel alignment and measuring devices 1 are located on the other side of the lifting machine 3 for carrying the vehicle, corresponding to the front and rear wheels on the other side of the vehicle. The other one four-wheel alignment and calibration device 2 is located between the two four-wheel alignment and measuring devices 1 located on the other side. The two four-wheel alignment and measuring devices 1 are configured to obtain calibration images of the calibration component 22 of the four-wheel alignment and calibration device 2 to calibrate the two four-wheel alignment and measuring devices 1 located on the other side. Therefore, the two calibration openings 261 in the three calibration openings 261 of each of the two four-wheel alignment and calibration devices 2 need to face different directions to correspond to the calibration of the two four-wheel alignment and measuring devices 1. The two four-wheel alignment and calibration devices 2 located on opposite sides of the lifting machine 3 for carrying the vehicle also need to be calibrated with each other. Therefore, the remaining calibration opening 261 among the three calibration openings 261 of each of the two four-wheel alignment and calibration devices 2 needs to correspond to the calibration of the four-wheel alignment and calibration device 2 on the opposite side. Therefore, it is necessary to arrange the three calibration openings 261 to face three different directions.

By adopting the above technical solution, the calibration space is formed with calibration openings 261 corresponding to three different calibration directions.

The above are only preferred embodiments of the present application and are not intended to limit the present application. Any modifications, equivalent substitutions, and improvements made within the spirit and principles of the present application shall be included within the scope of protection of the present application.

What is claimed is:

1. A four-wheel aligner, comprising:
four four-wheel alignment and measuring devices and two four-wheel alignment and calibration devices;
wherein the four four-wheel alignment and measuring devices are configured to be placed one by one corresponding to sides of the four tires of a vehicle to be aligned, one of the two four-wheel alignment and calibration devices is arranged between two of the four four-wheel alignment and measuring devices located at a side of the vehicle to be aligned, another one of the two four-wheel alignment and calibration devices is arranged between another two of the four four-wheel alignment and measuring devices located at another side of the vehicle to be aligned, and the two four-wheel alignment and calibration devices are configured to be oppositely arranged on two sides of the vehicle to be aligned; the four four-wheel alignment and measuring devices are configured to obtain images of the tires and to analyze alignment information of the tires; and one of the two four-wheel alignment and calibration devices is configured to calibrate two four-wheel alignment and measuring devices located at a same side of the one of the two four-wheel alignment and another one of the two four-wheel alignment and calibration devices on an opposite side.

2. The four-wheel aligner according to claim 1, wherein the four-wheel aligner further comprises a user terminal configured to communicate with the four four-wheel alignment and measuring devices and the two four-wheel alignment and calibration devices, and the user terminal is configured to receive, display, and transmit measurement information obtained by the four four-wheel alignment and measuring devices and calibration information obtained by the two four-wheel alignment and calibration devices.

3. The four-wheel aligner according to claim 1, wherein the four-wheel aligner further comprises a plurality of fixing members arranged at the four four-wheel alignment and measuring devices and the two four-wheel alignment and calibration devices, and the plurality of fixing members are configured to be fixedly connected to a lifting machine for carrying a vehicle.

4. The four-wheel aligner according to claim 3, wherein the plurality of fixing members are magnetic members capable of being magnetically fixed to the lifting machine for carrying the vehicle.

5. The four-wheel aligner according to claim 1, wherein each of the four four-wheel alignment and measuring devices comprises a support seat, a support rod connected with an end of the support seat, a laser device, and a first photographic device arranged on the support rod; a length direction of the support rod is inclined to a length direction of the support seat, the laser device is configured to project a laser image onto a surface of each tire, and the first photographic device is configured to obtain the laser image and obtain the alignment information of the tire based on the laser image.

6. The four-wheel aligner according to claim 5, wherein the laser device comprises a inclined support and a laser module arranged on the inclined support; the inclined support is configured to support the laser module so that a central axis of the laser module is inclined to a plane where a wheel hub of the tire to be measured is located, and the laser module projects the laser image from the inclined support to the surface of the tire.

7. The four-wheel aligner according to claim 5, wherein each of the four four-wheel alignment and measuring devices further comprises a second photographic device arranged on the support seat, and the second photographic device is configured to obtain an image of each of the four four-wheel alignment and measuring devices to calibrate a position of each of the four four-wheel alignment and measuring devices.

8. The four-wheel aligner according to claim 7, wherein the second photographic device comprises: a second camera housing arranged on the support seat, and a second camera host arranged in the second camera housing; the second camera housing is provided with an accommodating cavity and a second camera opening in communication with the accommodating cavity, the second camera host is arranged in the accommodating cavity, and the second camera host is configured to take images through the second camera opening; and an extension direction of a central axis of the second camera host is inclined to an extension direction of a connecting line between the second photographic device and one of the two four-wheel alignment and calibration devices configured to calibrate the second photographic device.

9. The four-wheel aligner according to claim 1, wherein each of the two four-wheel alignment and calibration devices comprises a calibration seat, a calibration component, a third photographic device, and a photographic device connector; the calibration seat is defined to have at least two calibration directions parallel to the calibration seat, the calibration component is arranged on the calibration seat and is located in the calibration direction, an end of the photographic device connector is connected with the calibration seat, and an other end of the photographic device connector is connected with the third photographic device, so that projections of the third photographic device and the calibration component along any of the calibration directions are not coincide with each other.

10. The four-wheel aligner according to claim 9, wherein the photographic device connector comprises: a first connection segment, and a second connection segment connected with the first connection segment; the first connection segment is configured to connect with the calibration seat, and the first connection segment is arranged along a first direction perpendicular to a side of the calibration seat; the second connection segment is configured to connect with the third photographic device, the second connection segment extends along a second direction perpendicular to the first direction to enable the third photographic device to take images of another calibration seat while avoiding the side of the calibration seat.

11. The four-wheel aligner according to claim 2, wherein each of the four four-wheel alignment and measuring devices comprises a support seat, a support rod connected with an end of the support seat, a laser device, and a first photographic device arranged on the support rod;
a length direction of the support rod is inclined to a length direction of the support seat, the laser device is configured to project a laser image onto a surface of each tire, and the first photographic device is configured to obtain the laser image and obtain the alignment information of the tire based on the laser image.

12. The four-wheel aligner according to claim 3, wherein each of the four four-wheel alignment and measuring devices comprises a support seat, a support rod connected with an end of the support seat, a laser device, and a first photographic device arranged on the support rod; a length direction of the support rod is inclined to a length direction of the support seat, the laser device is configured to project a laser image onto a surface of each tire, and the first photographic device is configured to obtain the laser image and obtain the alignment information of the tire based on the laser image.

13. The four-wheel aligner according to claim 4, wherein each of the four four-wheel alignment and measuring devices comprises a support seat, a support rod connected with an end of the support seat, a laser device, and a first photographic device arranged on the support rod; a length direction of the support rod is inclined to a length direction of the support seat, the laser device is configured to project a laser image onto a surface of each tire, and the first photographic device is configured to obtain the laser image and obtain the alignment information of the tire based on the laser image.

14. The four-wheel aligner according to claim 2, wherein each of the two four-wheel alignment and calibration devices comprises a calibration seat, a calibration component, a third photographic device, and a photographic device connector; the calibration seat is defined to have at least two calibration directions parallel to the calibration seat, the calibration component is arranged on the calibration seat and is located in the calibration direction, an end of the photographic device connector is connected with the calibration seat, and an other end of the photographic device connector is connected with the third photographic device, so that projections of the third photographic device and the calibration component along any of the calibration directions are not coincide with each other.

15. The four-wheel aligner according to claim 3, wherein each of the two four-wheel alignment and calibration devices comprises a calibration seat, a calibration component, a third photographic device, and a photographic device connector; the calibration seat is defined to have at least two calibration directions parallel to the calibration seat, the calibration component is arranged on the calibration seat and is located in the calibration direction, an end of the photographic device connector is connected with the calibration seat, and an other end of the photographic device connector is connected with the third photographic device, so that projections of the third photographic device and the calibration component along any of the calibration directions are not coincide with each other.

16. The four-wheel aligner according to claim 4, wherein each of the two four-wheel alignment and calibration devices comprises a calibration seat, a calibration component, a third photographic device, and a photographic device connector; the calibration seat is defined to have at least two calibration directions parallel to the calibration seat, the calibration component is arranged on the calibration seat and is located in the calibration direction, an end of the photographic device connector is connected with the calibration seat, and an other end of the photographic device connector is connected with the third photographic device, so that projections of the third photographic device and the calibration component along any of the calibration directions are not coincide with each other.
